(19) United States
(12) Patent Application Publication
(10) Pub. No.: US 2012/0209921 A1
(43) Pub. Date: Aug. 16, 2012

(54) Instant Message Management Method and Apparatus

(75) Inventors: Toni Adafin, Rochester, MN (US); Perry A. Bakken, Rochester, MN (US); Joel A. Gotelaere, Rochester, MN (US); Michael A. Jones, Rochester, MN (US); Charles H. Luong, Rochester, MN (US); John H. Mohlke, Rochester, MN (US); Jeffrey E. Thompson, Rochester, MN (US); Carl C. Voss, Rochester, MN (US)

(73) Assignee: International Business Machines Corporation, Armonk, NY (US)

(21) Appl. No.: 13/024,352

(22) Filed: Feb. 10, 2011

(51) Int. Cl. G06F 15/16

(52) U.S. Cl. 709/206

(57) ABSTRACT

The technology here described contemplates storing an incoming instant message and determining the subsequent deletion of the stored message by distinguishing whether the message has been noticed by the user, even though there may have been a system or program failure between the time of the message's arrival and the time that the user attends to the message.

### FIELD AND BACKGROUND OF INVENTION

What is here disclosed is a method, computer product, and computer readable media product related to the handling of instant messages exchanged between computer systems over a network. The network may be of any sort, a local area network within a workplace or a connection through the Internet.

Instant messaging, also know as IM, is a way of communicating which has come to be of significance in business and in social networks. As the use of the technology has grown, it has become more important to assure that messages exchanged through an IM channel are noticed by users and, where appropriate, lead to a response. What is here described is an advance in IM technology which assures that messages are brought to the attention of a user even in the event that the user's computer system or IM reader program crashes or inappropriately ends operation.

### SUMMARY OF THE INVENTION

With the foregoing in mind, the technology here described contemplates storing an incoming message and determining the subsequent deletion of the stored message by distinguishing whether the message has been noticed by the user, even though there may have been a system or program failure between the time of the message's arrival and the time that the user attends to the message.

### BRIEF DESCRIPTION OF DRAWINGS

Some of the purposes of the invention having been stated, others will appear as the description proceeds, when taken in connection with the accompanying drawings, in which:

FIGS. 1A and 1B together present a flow chart illustrating the method of the present invention;

FIG. 2 is representative example of a computer system in which the method of FIGS. 1A and 1B may be implemented; and

FIG. 3 is a representation of a tangible computer readable medium which carries program code effective when executing on the computer system of FIG. 2 to implement the method of FIGS. 1A and 1B.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The technology here described relates particularly to user computer systems connected to other user's systems through a network of some type and in circumstances where the computer system has an application program installed which is an instant message reader program capable, when executing, of opening received instant messages (or IM) to allow the user to read such messages.

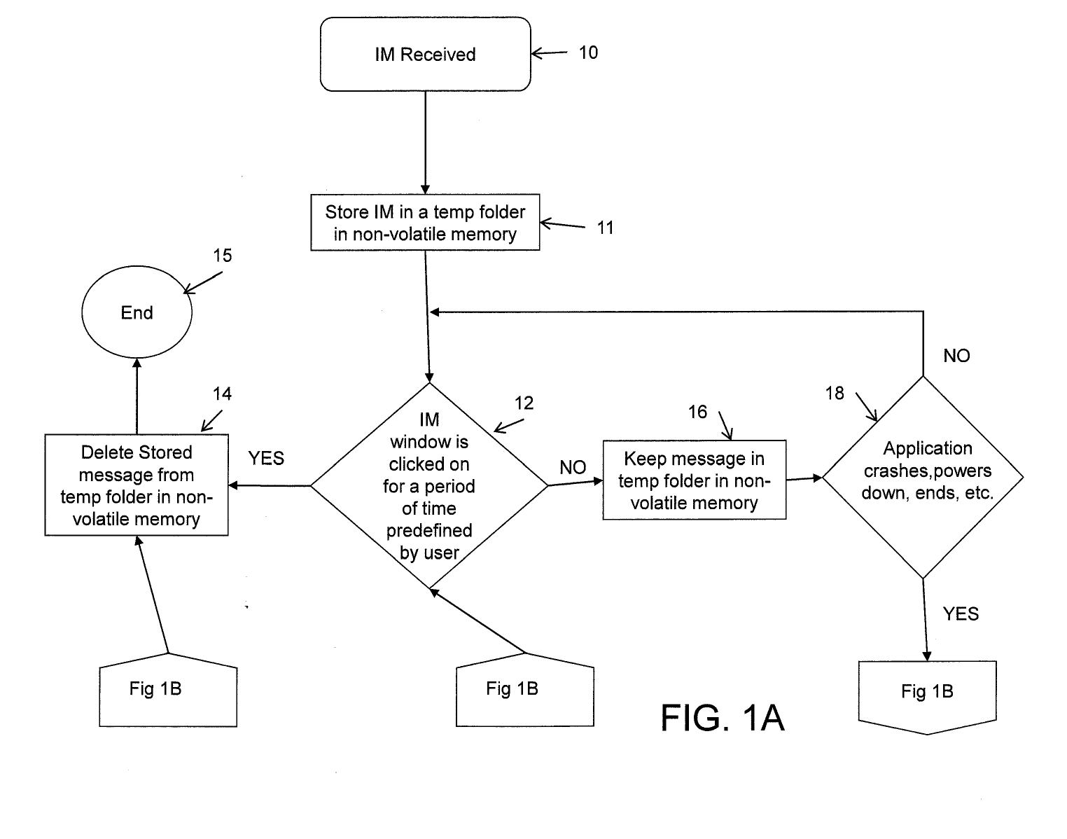

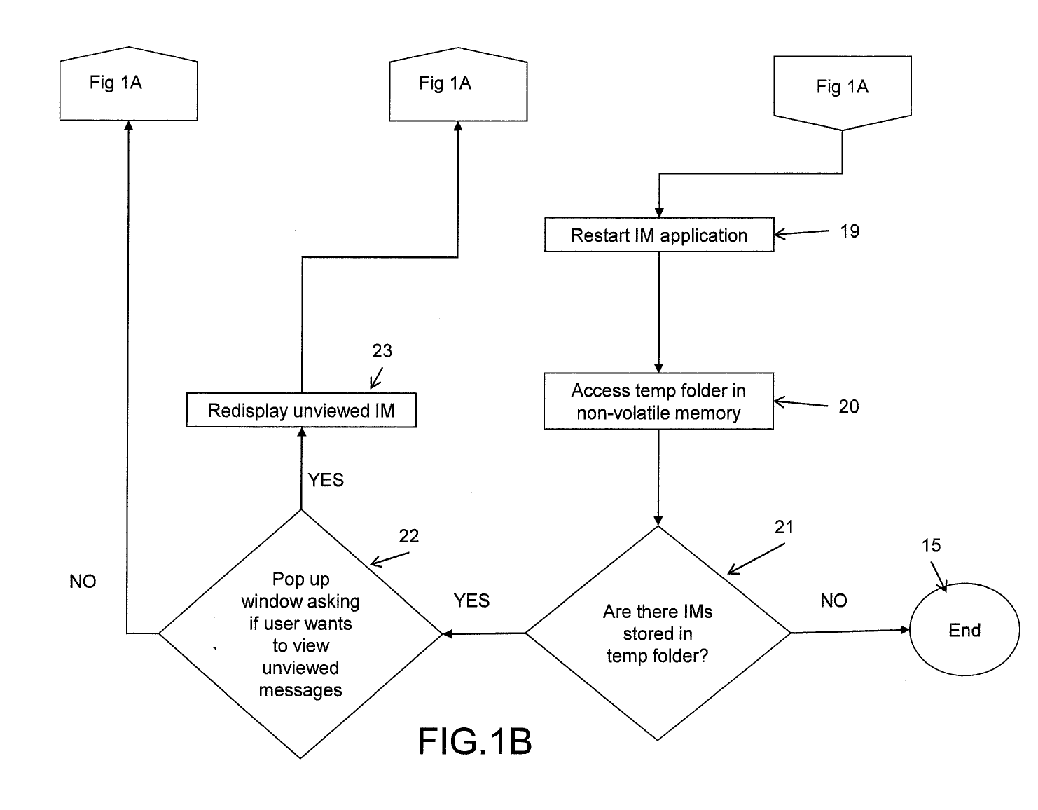

Referring now to FIGS. 1A and 1B, it will be understood that a user may receive an instant message, arriving as an instant message data file, while the user's computer system is in an idle state. Heretofore, If the user's computer system and/or the IM reader program powers down, freezes, or experiences a crash after receipt of an instant message data file (or IMDF), any IMDF which have remained unviewed by the user will be lost. That is, the received IMDF are ephemeral, transitory or fugitive, having been unopened by the user's instant message reader program. In accordance with what is here described, an instant message data file received (as at 10 in FIG. 1A) is stored in the memory of the user's computer system. Preferably, such storage is in the non-volatile memory of the system, as indicated at 11 in FIG. 1A (and see the discussion below).

The process then proceeds by distinguishing user accesses to the instant message reader program which continue for less than a timed interval (at 12) and responding to the accesses having been less than the timed interval by continuing to store the received instant message data file (at 16). Should the accesses have been for more than the timed interval, then the stored IMDF is deleted (as at 14) and the process ends (as at 15).

Should it be determined that the computer system and/or the instant message reader program has ceased operation (at 18), the method responds to subsequent initiation of the instant message reader program (at 19) by accessing the storage location of any stored IMDF (at 20) and initiating a display (at 22) offering the user a choice between displaying any stored instant message data file and ignoring any stored instant message data file.

The process has branch or decision points (12,18, 21,22) which cause various paths to taken depending upon detected conditions. Thus, a determination that the instant message reader program was accessed for the time interval will result in deletion of any stored IMDF (at 14). Further, the process will return to the relevant decision point (12) should a user select the redisplay of an unviewed IMDF (at 22 and 23). Should a user determine that unviewed messages will not be viewed, the process proceeds to the deletion of the stored IMDF (at 14). Similarly, should the process determine (at 21) that there are no stored IMDFs, then the process proceeds to an end. The process may also provide for notification to the sender that the instant message was not viewed.

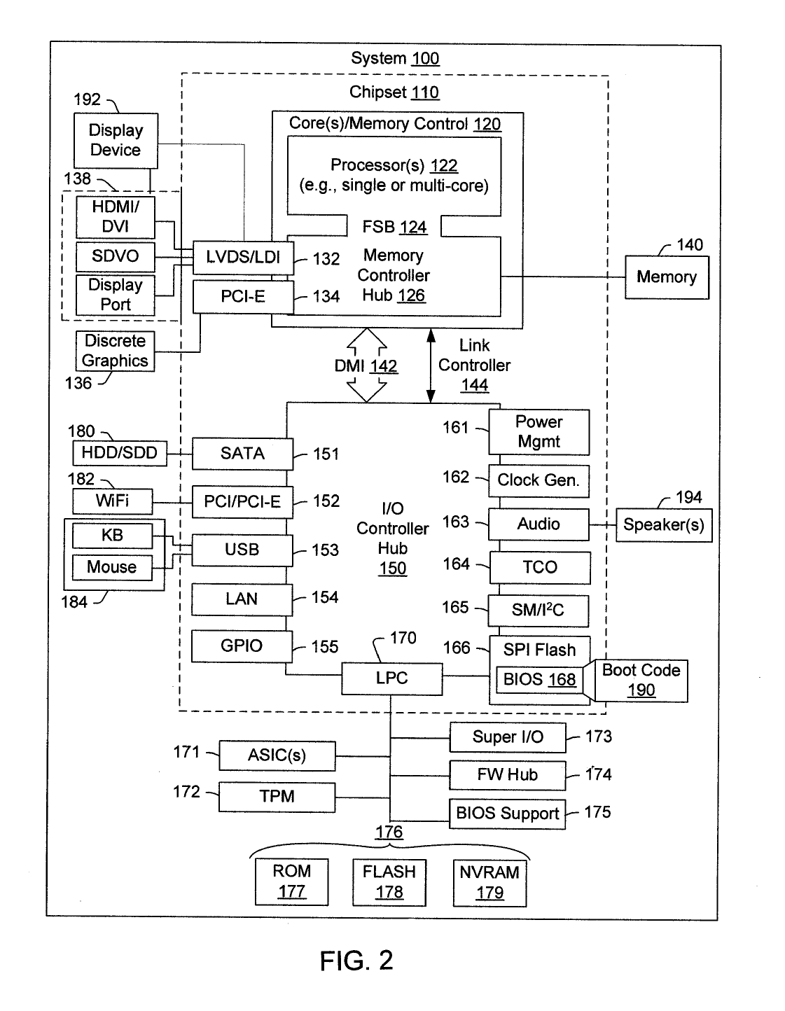

FIG. 2 depicts a block diagram of an illustrative exemplary computer system 100. The system 100 may be a notebook computer system, a desktop computer system, or a workstation computer system; however, as apparent from the description herein, a client device, a server or other machine may include other features or only some of the features of the system 100.

The system 100 of FIG. 2 includes a so-called chipset 110 (a group of integrated circuits, or chips, that work together, chipsets) with an architecture that may vary depending on manufacturer (e.g., INTEL®, AMD®, etc.). The architecture of the chipset 110 includes a core and memory control group 120 and an I/O controller hub 150 that exchange information (e.g., data, signals, commands, etc.) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (e.g., single or multi-core) and a memory controller hub 126 that exchange information via a front side bus (FSB) 124; noting that components of the group 120 may be integrated in a chip that supplants the conventional “northbridge” style architecture.

In FIG. 2, the memory controller hub 126 interfaces with memory 140 (e.g., to provide support for a type of RAM that may be referred to as “system memory”). The memory controller hub 126 further includes a LVDS interface 132 for a display device 192 (e.g., a CRT, a flat panel, a projector, etc.). A block 138 includes some technologies that may be supported via the LVDS interface 132 (e.g., serial digital video, HDMI/DVI, display port). The memory controller hub 126 also includes a PCI-express interface (PCI-E) 134 that may support discrete graphics 136.

In FIG. 2, the I/O hub controller 150 includes a SATA interface 151 (e.g., for non-volatile storage devices such as HDDs, SDDs 180, etc.), a PCI-E interface 152 (e.g., for wireless connections 182), a USB interface 153 (e.g., for input devices 184 such as keyboard, mice, cameras, phones, storage, etc.), a network interface 154 (e.g., LAN through which IDMF may be exchanged), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (e.g., for speakers 194), a TCO interface 164, a system management bus interface 165, and SPI Flash 166, which can include BIOS 168 and boot code 190. The I/O hub controller 150 may include gigabit Ethernet support.

The system 100, upon power on, may be configured to execute boot code 190 for the BIOS 168, as stored within the SPI Flash 166, and thereafter processes data under the control of one or more operating systems and application software such as an instant message reader program (e.g., stored in system memory 140). An operating system may be stored in any of a variety of locations and accessed, for example, according to instructions of the BIOS 168. As described herein, a device may include fewer or more features than shown in the system 100 of FIG. 2.

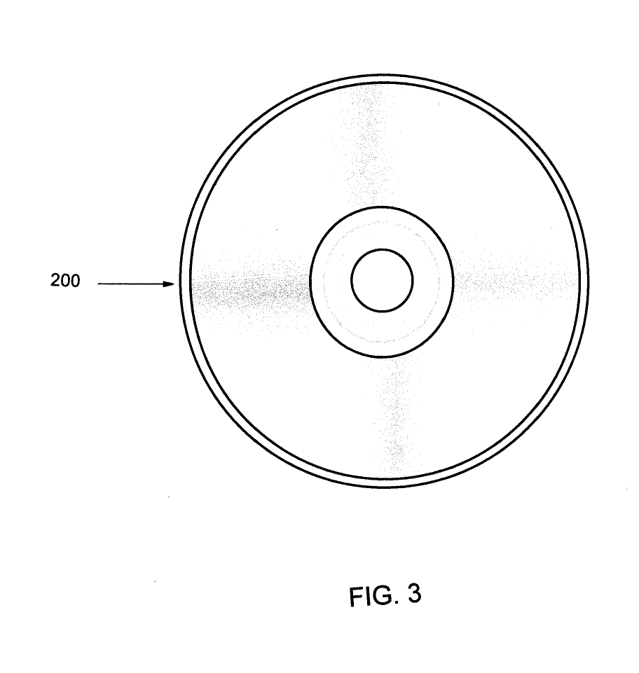

FIG. 3 illustrates one form of tangible computer readable media (here, an optical disc 200). Such a tangible media is contemplated as carrying the program code effective, when executing on the processor 122 of a system such as that of FIG. 2, to perform the steps of FIGS. 1A and 1B as described above.

In the drawings and specifications there has been set forth a preferred embodiment of the invention and, although specific terms are used, the description thus given uses terminology in a generic and descriptive sense only and not for purposes of limitation.

What is claimed is:

1. A method comprising:
storing a received instant message data file in the memory of a user's computer system which has an instant message reader program;
distinguishing user accesses to the instant message reader program which continue for less than a timed interval and responding to the accesses having been less than the times interval by continuing to store the received instant message data file;
determining whether the instant message reader program has ceased operation; and
if operation has ceased, responding to subsequent initiation of the instant message reader program by initiating a display offering the user a choice between displaying any stored instant message data file and ignoring any stored instant message data file.

2. A method according to claim 1 wherein the received instant message data file is stored in non-volatile memory of the user's computer system

3. A method according to claim 1 further comprising distinguishing user accesses to an instant message reader program which continue for more than a timed interval and responding to the accesses having been more then the times interval by removing any stored instant message data file from the computer system memory.

4. A method according to claim 3 wherein the distinguishing of user accesses determines whether a received instant message data file has been read.

5. A method according to claim 1 wherein the responding to subsequent initiation of the instant message reader program comprises determining whether any instant message data file is stored.

6. A method according to claim 1 further comprising
distinguishing user accesses to an instant message reader program which continue for more than a timed interval;
responding to the accesses having been more then the timed interval by determining whether a received instant message data file has been read and removing any stored instant message data file which has been read from the computer system memory; and further wherein
responding to subsequent initiation of the instant message reader program comprises determining whether any instant message data file is stored.

7. A method according to claim 6 wherein the initiating of a display offering the user a choice between displaying any stored instant message data file and ignoring any stored instant message data file is responsive to a determination that an unread instant message data file is in storage.

8. A product comprising:
a tangible computer program storage device bearing program code accessible to a computer system and readable by the computer system from the device; and
program code stored in said device and effective when executing on computer system which has read the code from the device to:
store a received instant message data file in the memory of a user's computer system which has an instant message reader program;
distinguish user accesses to the instant message reader program which continue for less than a timed interval and respond to the accesses having been less than the times interval by continuing to store the received instant message data file;
determine whether the instant message reader program has ceased operation; and
if operation has ceased, respond to subsequent initiation of the instant message reader program by initiating a display offering the user a choice between displaying any stored instant message data file and ignoring any stored instant message data file.

9. A product according to claim 8 wherein the program code is effective to store a received instant message data file in non-volatile memory of the user's computer system

10. A product according to claim 8 wherein said program code is effective to distinguish user accesses to an instant message reader program which continues for more than a timed interval and respond to the accesses having been more then the times interval by removing any stored instant message data file from the computer system memory.

11. A product according to claim 10 wherein said program code is effective to distinguish user accesses as determining whether a received instant message data file has been read.

12. A product according to claim 8 wherein said program code in responding to subsequent initiation of the instant message reader program determines whether any instant message data file is stored.

13. A product according to claim 8 wherein said program code is effective to
distinguish user accesses to an instant message reader program which continue for more than a timed interval;
respond to the accesses having been more then the timed interval by determining that a received instant message data file has been read and removing any stored instant message data file which has been read from the computer system memory; and further to
respond to subsequent initiation of the instant message reader program by determining whether any instant message data file is stored.

14. A product according to claim 13 wherein said program code is effective to initiate a display offering the user a choice between displaying any stored instant message data file and ignoring any stored instant message data file in response to a determination that an unread instant message data file is in storage.

15. A product comprising:
a computer system having memory and program code stored in said memory, said program code effective when executing on said computer system to:
store a received instant message data file in the memory of a user's computer system which has an instant message reader program;
distinguish user accesses to the instant message reader program which continue for less than a timed interval and respond to the accesses having been less than the times interval by continuing to store the received instant message data file;
determine whether the instant message reader program has ceased operation; and
if operation has ceased, respond to subsequent initiation of the instant message reader program by initiating a display offering the user a choice between displaying any stored instant message data file and ignoring any stored instant message data file.

16. A product according to claim 15 wherein the program code is effective to store a received instant message data file in non-volatile memory of the user's computer system

17. A product according to claim 15 wherein said program code is effective to distinguish user accesses to an instant message reader program which continues for more than a timed interval and respond to the accesses having been more then the times interval by removing any stored instant message data file from the computer system memory.

18. A product according to claim 17 wherein said program code is effective to distinguish user accesses as determining whether a received instant message data file has been read.

19. A product according to claim 15 wherein said program code in responding to subsequent initiation of the instant message reader program determines whether any instant message data file is stored.

20. A product according to claim 15 wherein said program code is effective to
distinguish user accesses to an instant message reader program which continue for more than a timed interval;
respond to the accesses having been more then the timed interval by determining that a received instant message data file has been read and removing any stored instant message data file which has been read from the computer system memory; and further to
respond to subsequent initiation of the instant message reader program by determining whether any instant message data file is stored.
